(19) United States
(12) Patent Application Publication
(10) Pub. No.: US 2022/0043769 A1
(43) Pub. Date: Feb. 10, 2022

(54) Toroidal Systolic Array Processor for General Matrix Multiplication (GEMM) With Local Dot Product Output Accumulation

(71) Applicant: Fathom Radiant, PBC, Boulder, CO (US)

(72) Inventor: Andrea Giannini, West New York, NJ (US)

(21) Appl. No.: 17/382,287

(22) Filed: Jul. 21, 2021

Related U.S. Application Data
(60) Provisional application No. 63/054,477, filed on Jul. 21, 2020.

(51) Int. Cl. G06F 15/80; G06F 7/544; G06F 17/16

(52) U.S. Cl. CPC G06F 15/8046; G06F 17/16; G06F 7/5443

(57) ABSTRACT

A toroidal systolic array processor for GEMM with local dot-product output comprises an array of processing elements (PEs) arranged in rows and columns. User input circuitry provides input arrays A and B (and optionally G) as initial first values and second values before the array operation begins. Then, for each step of the array operation, first values and second values are received from other PEs in the array in a toroidal fashion. Each PE performs a fused multiply-add (FMA) operation based upon first values and second values received, whether from the input circuitry or from other PEs. At the end of the array process, each PE provides and output, for example a_{0,1}b_{1,0}+a_{0,0}b_{0,0} for the upper left hand PE in a 2×2 array. Depending upon user input, the array processor can compute A*B+G, A*B+C*D, etc.

### BACKGROUND OF THE INVENTION

### Field of the Invention

The present invention relates to a Domain Specific Architecture for GEMM based algorithms widely used in inference and training of Neural Network (NNs). In particular, the present invention relates to a toroidal Systolic Array processor for General Matrix Multiplication (GEMM) with local dot-product output accumulation.

### Discussion of Related Art

The following references are useful as background for the present invention.

[1] J. L. Hennessy and D. A. Patterson, Computer Architecture, Sixth Edition: A Quantitative Approach, 6th ed. San Francisco, Calif., USA: Morgan Kaufmann Publishers Inc., 2017.

[2] K. T. Johnson, A. R. Hurson, and B. Shirazi, “General-purpose systolic arrays,” Computer (Long. Beach. Calif.), vol. 26, no. 11, pp. 20-31, November 1993.

[3] J.-M. Muller et al., Handbook of Floating-Point Arithmetic, 1st ed. Birkhäuser Basel, 2009.

### SUMMARY OF THE INVENTION

It is an object of the present invention to provide improved apparatus and methods for Domain Specific Architecture [1] for GEMM based algorithms widely used in inference and training of Neural Network (NNs). In particular, the present invention comprises a toroidal Systolic Array processor for General Matrix Multiplication (GEMM) with local dot-product output accumulation.

The present invention includes an architecture that is tailored to the requirements of NNs training, but it can be generalized to a larger domain of applications developed on top of GEMM operations.

The design embeds L\hat{ }2 Processing Elements (PE) arranged in a systolic array [2] fashion, where L indicates the number of matrix rows and columns assuming two square matrices of size L×L. Each element of the output matrix has an associated PE, achieving an overall matrix multiplication time in number of clock cycles of L, if we consider the systolic array time from when the input A and B are loaded in the A and B registers. For instance, in a 2×2 example, it takes 2 clock cycles after the inputs are loaded to calculate the matrix multiplication.

### BRIEF DESCRIPTION OF THE DRAWINGS

FIG. 1 is a schematic diagram of a Processing Element sample architecture.

FIGS. 2A-E are schematic drawings illustrating the structure and operation of an embodiment of the Processing Element of FIG. 1.

FIG. 3 is a schematic diagram of a Toroidal Systolic Array Processor comprising four Processing Elements.

FIGS. 4A-4C show an example of the Toroidal Systolic Array of FIG. 3 in operation over three clock cycles.

FIGS. 5A-5D are schematic drawings illustrating the structure and operation of another embodiment of a 3×3 Toroidal Systolic Array according to the present invention.

FIG. 6 is a schematic diagram of a generic Toroidal Systolic Array having many rows and columns.

### DETAILED DESCRIPTION OF THE INVENTION

Table 1 provides a list of elements of the present invention and their associate reference numbers.

TABLE 1

| Ref. No. | Element |
|---|---|
| 100, 200, 300, 400 | Processing element |
| 102, 202, 302, 402 | Input a |
| 103, 203, 303, 403 | Input b |
| 104, 204, 304, 404 | Input g |
| 106, 206, 306, 406 | Output g_o |
| 108, 208, 308, 408 | Output a_o (input a_i shifted right) |
| 110, 210, 310, 410 | Output b_o (input b_i shifted down) |
| 120, 220, 320, 420 | Input a_i (from a_o shifted right) |
| 122, 222, 322, 422 | Input b_i (from b_o shifted down) |
| 150A, 150B, 150G | Selection bits |
| 152A, 152B, 156 | Load enable |
| 154 | Fused Multiply-Add (FMA) |
| 500 | Toroidal systolic array GEMM processor |
| 502, 504, 506, 508, | Processing elements |
| 510, 512, 514 | |

The present invention embeds L² Processing Elements 100 (PE) arranged in a systolic array fashion, where L indicates the number of matrix rows and columns assuming two square matrices of size L×L. Each element of the output matrix has an associated PE 100, achieving an overall matrix multiplication time in number of clock cycles of L if we don't consider the input loading (1 clock cycle) in the calculation.

Each processing element takes, for example, three floating point inputs (a, b, g), evaluating in a single clock cycle the Fused Multiply-Add (FMA) operation:

o=round(a·b+g),

where round is a non-linear function of its input related to the architecture of the Fused Multiply-Add (FMA) 154. From now on the inputs a and b will be referred as multiplicands, the input g as addend of the FMA operation. Note that the architecture is flexible regarding the input format. For instance, if the FMA is a signed integer FMA, and a, b and g are signed integers, the systolic array works.

The PEs are arranged in a torus mesh and may utilize a special arrangement of the input matrices (not shown) to provide a particular desired result. Precisely, considering L=3 with the following input assignments:

$$A = ( \begin{matrix}{a}_{0 , 0} & {a}_{0 , 1} & {a}_{0 , 2} \\ {a}_{1 , 0} & {a}_{1 , 1} & {a}_{1 , 2} \\ {a}_{2 , 0} & {a}_{2 , 1} & {a}_{2 , 2}\end{matrix} ) mapped as ( \begin{matrix}{a}_{0 , 2} & {a}_{0 , 1} & {a}_{0 , 0} \\ {a}_{1 , 1} & {a}_{1 , 0} & {a}_{1 , 2} \\ {a}_{2 , 0} & {a}_{2 , 2} & {a}_{2 , 1}\end{matrix} )$$

$$B = ( \begin{matrix}{b}_{0 , 0} & {b}_{0 , 1} & {b}_{0 , 2} \\ {b}_{1 , 0} & {b}_{1 , 1} & {b}_{1 , 2} \\ {b}_{2 , 0} & {b}_{2 , 1} & {b}_{2 , 2}\end{matrix} ) mapped as ( \begin{matrix}{b}_{2 , 0} & {b}_{1 , 1} & {b}_{0 , 2} \\ {b}_{1 , 0} & {b}_{0 , 1} & {b}_{2 , 2} \\ {b}_{0 , 0} & {b}_{2 , 1} & {b}_{1 , 2}\end{matrix} )$$

This provides the output:

$$O = A \cdot B = ( \begin{matrix}{o}_{0 , 0} & {o}_{0 , 1} & {o}_{0 , 2} \\ {o}_{1 , 0} & {o}_{1 , 1} & {o}_{1 , 2} \\ {o}_{2 , 0} & {o}_{2 , 1} & {o}_{2 , 2}\end{matrix} ) mapped as ( \begin{matrix}{o}_{0 , 0} & {o}_{0 , 1} & {o}_{0 , 2} \\ {o}_{1 , 0} & {o}_{1 , 1} & {o}_{1 , 2} \\ {o}_{2 , 0} & {o}_{2 , 1} & {o}_{2 , 2}\end{matrix} )$$

An innovative aspect of the proposed implementation is included in the accumulation of the dot-product elements. Each output element o_{i,j} (with i=0, . . . , L−1, j=0, . . . , L−1) of the output matrix represents the dot-product between the unmapped i row of the A matrix with the unmapped j column of the B matrix. The dot-product accumulation of element o_{i,j} is entirely processed by its related PE_{i,j}, shifting each mapped element a_{i,j} right along the first output matrix dimension and each mapped element b_{i,j} down along the second output matrix dimension by one position per clock cycle. This is assuming that the first dimension is row and second dimension is column, so a follows the row (first dimension), b follows the column (second dimension).

The systolic array architecture is in charge of shifting the inputs by one position per clock cycle following the previous rules for the starting arrangement of the input matrices elements. From the previous example, indicating with A(t) the mapping of the input matrix A at the generic cycle time t, the output matrix is calculated evaluating L² products per cycle, and accumulating a total of L products per processing element. Each PE executes one FMA (one multiplication and one addition) per clock cycle. The total number of FMAs (products and additions) ends up being, for example, L during the entire systolic array operation, which makes sense since the systolic array takes L cycles to finish (1 product/cycle/PE*L cycles=L product/PE)

Assuming A(0) and B(0) given, the circuit circular shifts the input matrices as the following:

$$A ( 0 ) = ( \begin{matrix}{a}_{0 , 2} & {a}_{0 , 1} & {a}_{0 , 0} \\ {a}_{1 , 1} & {a}_{1 , 0} & {a}_{1 , 2} \\ {a}_{2 , 0} & {a}_{2 , 2} & {a}_{2 , 1}\end{matrix} ) \\ B ( 0 ) = ( \begin{matrix}{b}_{2 , 0} & {b}_{1 , 1} & {b}_{0 , 2} \\ {b}_{1 , 0} & {b}_{0 , 1} & {b}_{2 , 2} \\ {b}_{0 , 0} & {b}_{2 , 1} & {b}_{1 , 2}\end{matrix} ) \\ A ( 1 ) = ( \begin{matrix}{a}_{0 , 0} & {a}_{0 , 2} & {a}_{0 , 1} \\ {a}_{1 , 2} & {a}_{1 , 1} & {a}_{1 , 0} \\ {a}_{2 , 1} & {a}_{2 , 0} & {a}_{2 , 2}\end{matrix} ) \\ B ( 1 ) = ( \begin{matrix}{b}_{0 , 0} & {b}_{2 , 1} & {b}_{1 , 2} \\ {b}_{2 , 0} & {b}_{1 , 1} & {b}_{0 , 2} \\ {b}_{1 , 0} & {b}_{0 , 1} & {b}_{2 , 2}\end{matrix} ) \\ A ( 2 ) = ( \begin{matrix}{a}_{0 , 1} & {a}_{0 , 0} & {a}_{0 , 2} \\ {a}_{1 , 0} & {a}_{1 , 2} & {a}_{1 , 1} \\ {a}_{2 , 2} & {a}_{2 , 1} & {a}_{2 , 0}\end{matrix} ) \\ B ( 2 ) = ( \begin{matrix}{b}_{1 , 0} & {b}_{0 , 1} & {b}_{2 , 2} \\ {b}_{0 , 0} & {b}_{2 , 1} & {b}_{1 , 2} \\ {b}_{2 , 0} & {b}_{1 , 1} & {b}_{0 , 2}\end{matrix} ) \qquad$$

The present Systolic Array is unaware of the input arrangements, generalizing the architecture for matrix multiply operations between normal and/or transposed input matrices. It allows to implement also elementwise additions or multiplications of matrices thanks to the FMA hardware present in each processing element that can act as a hardware multiplier or adder forcing the addend input to 0 or forcing one of the multiplier inputs to 1 respectively.

Processing Element Architecture

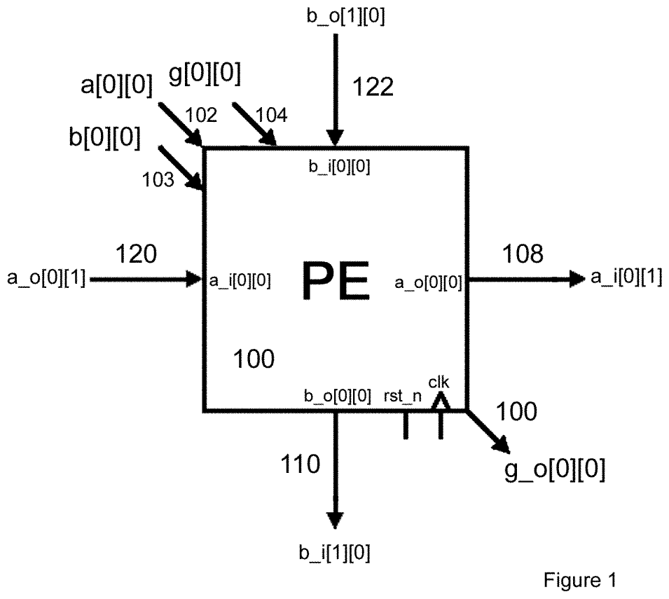

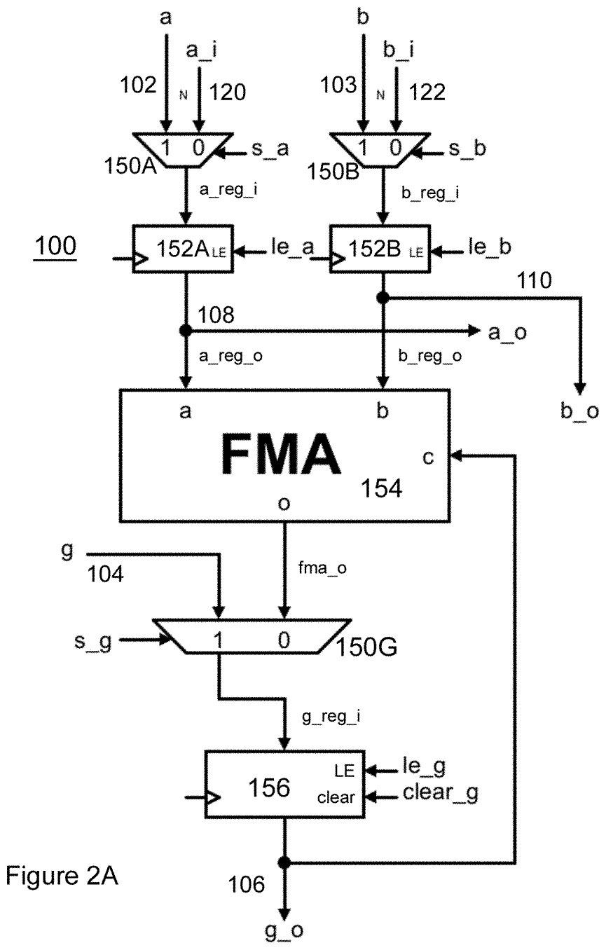

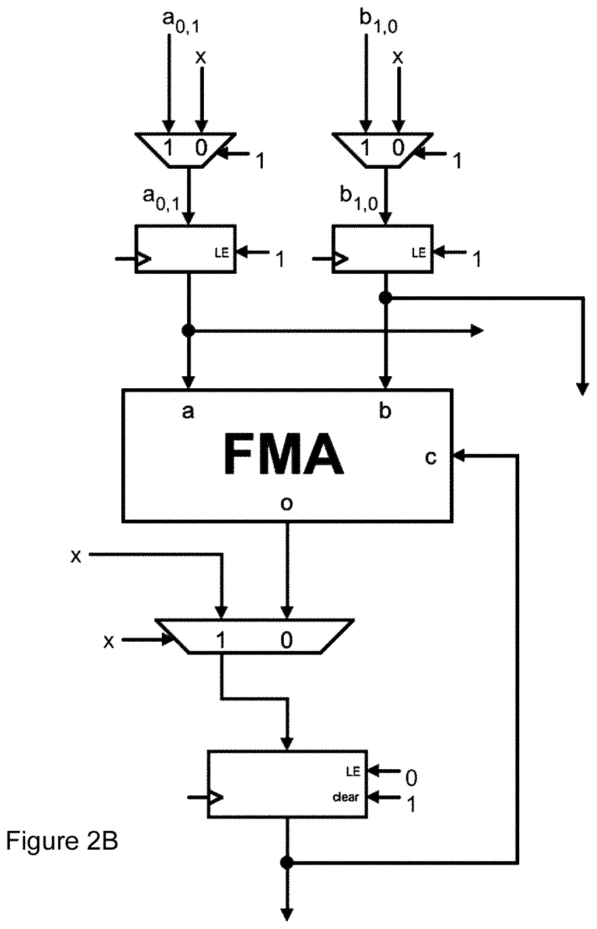

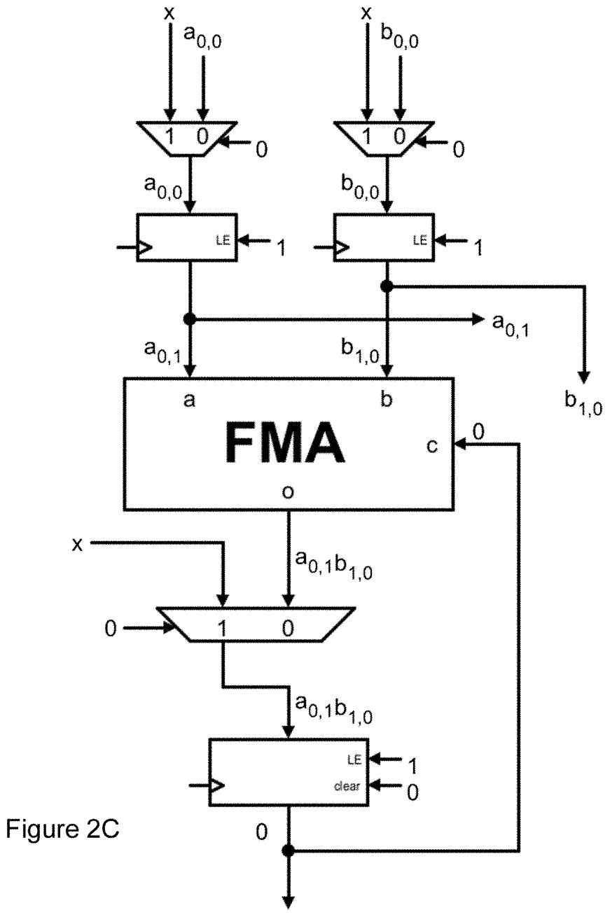

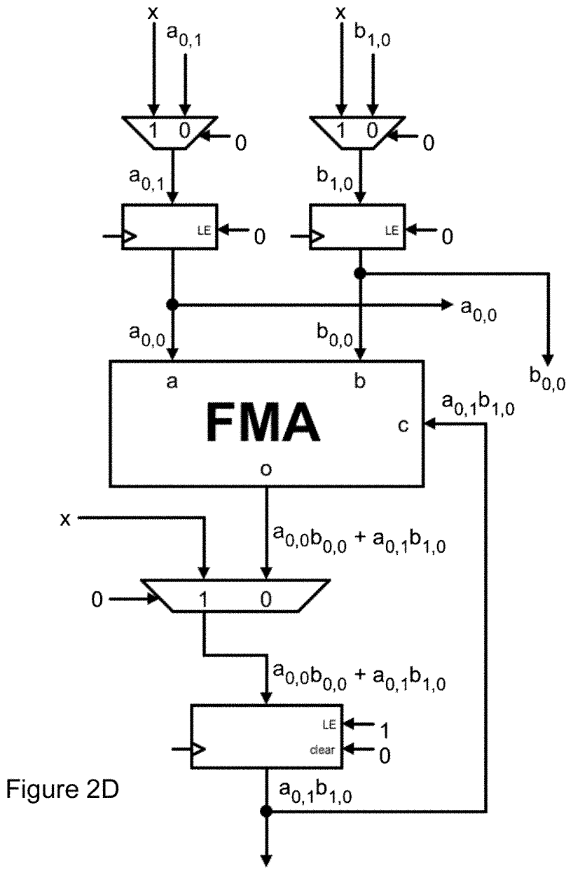

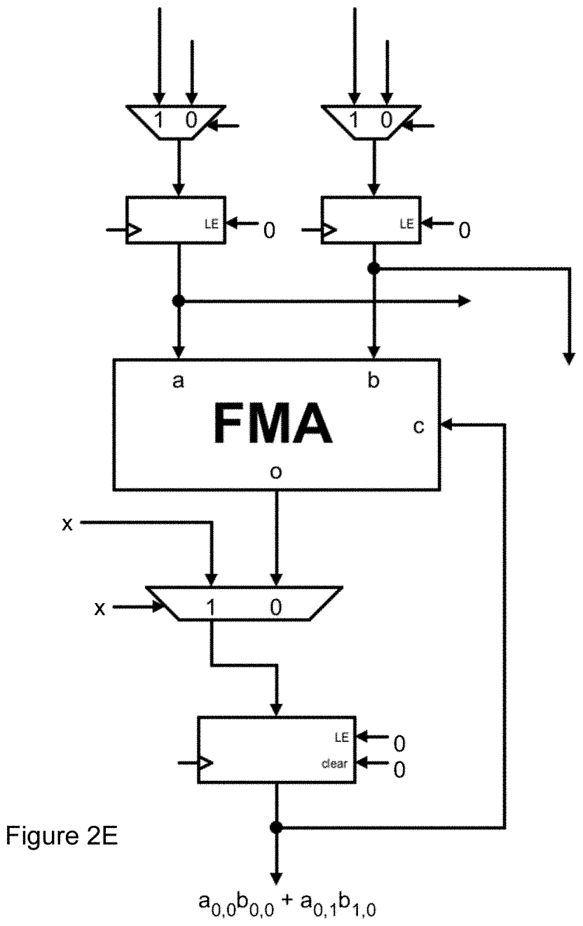

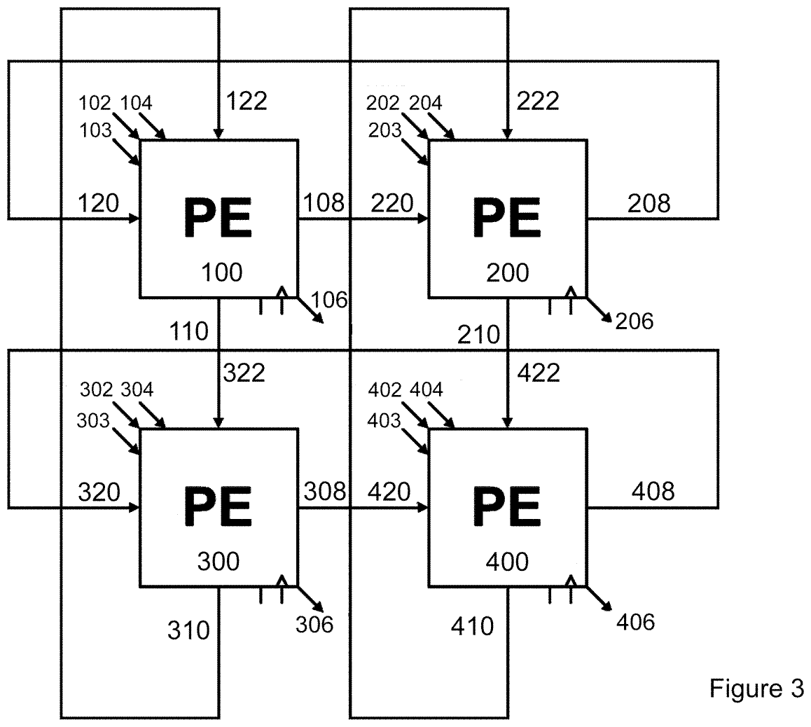

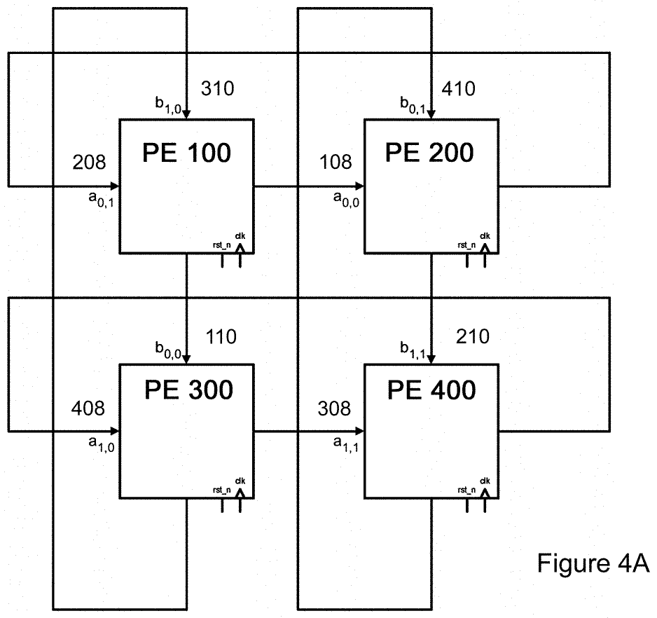

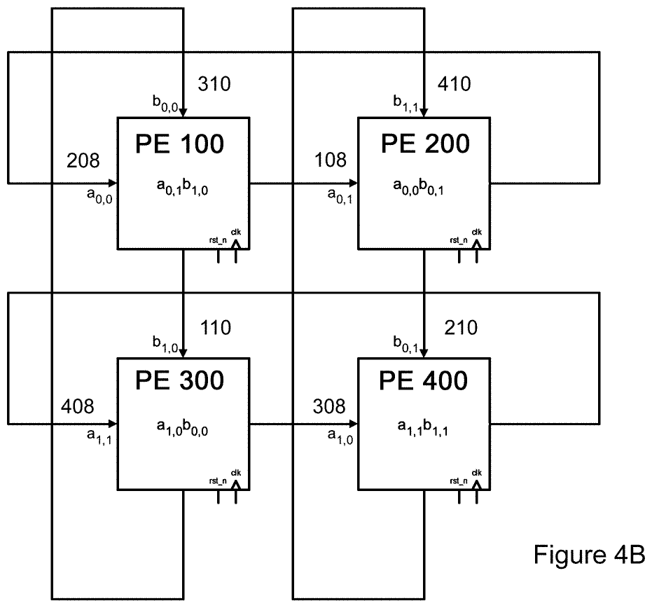

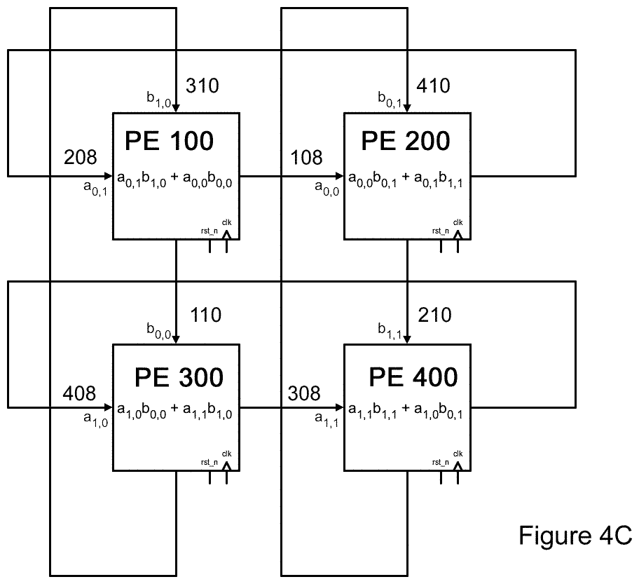

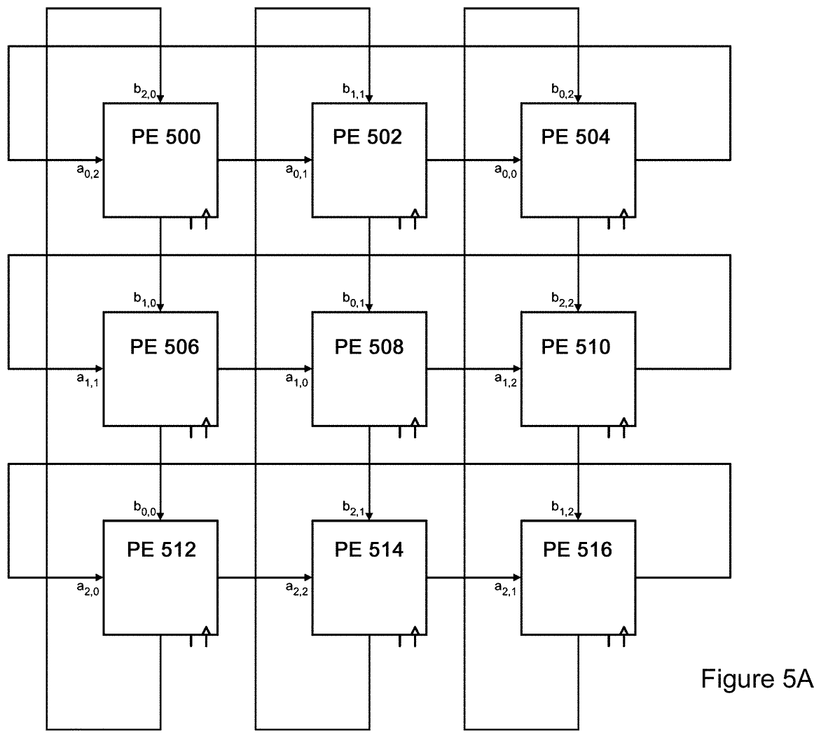

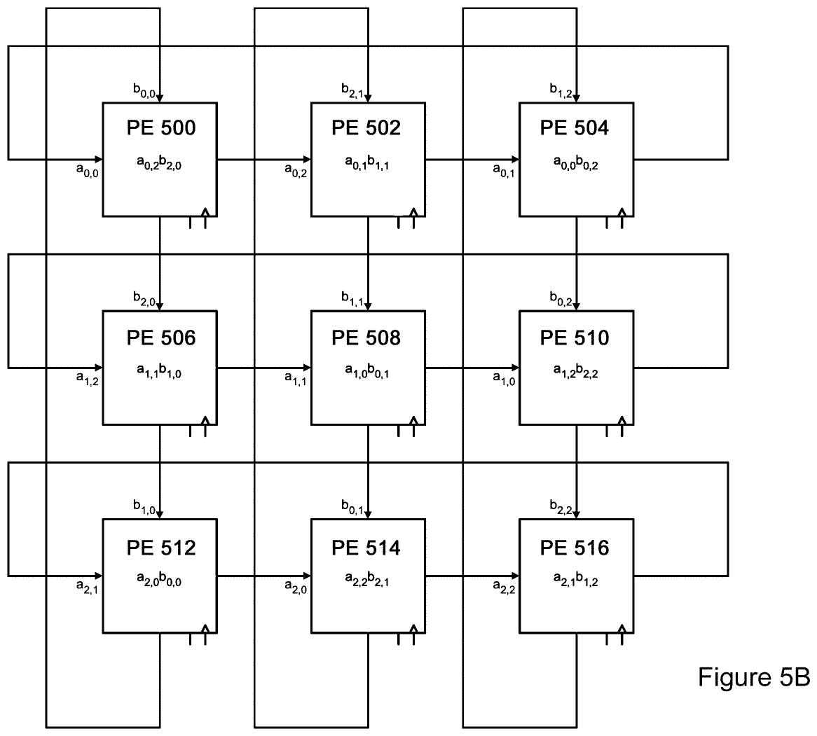

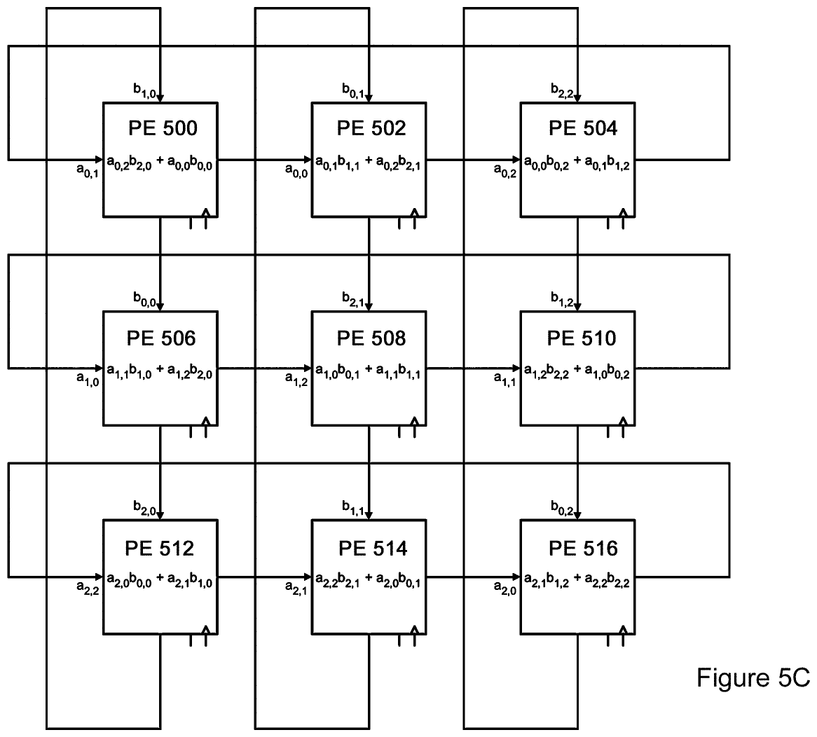

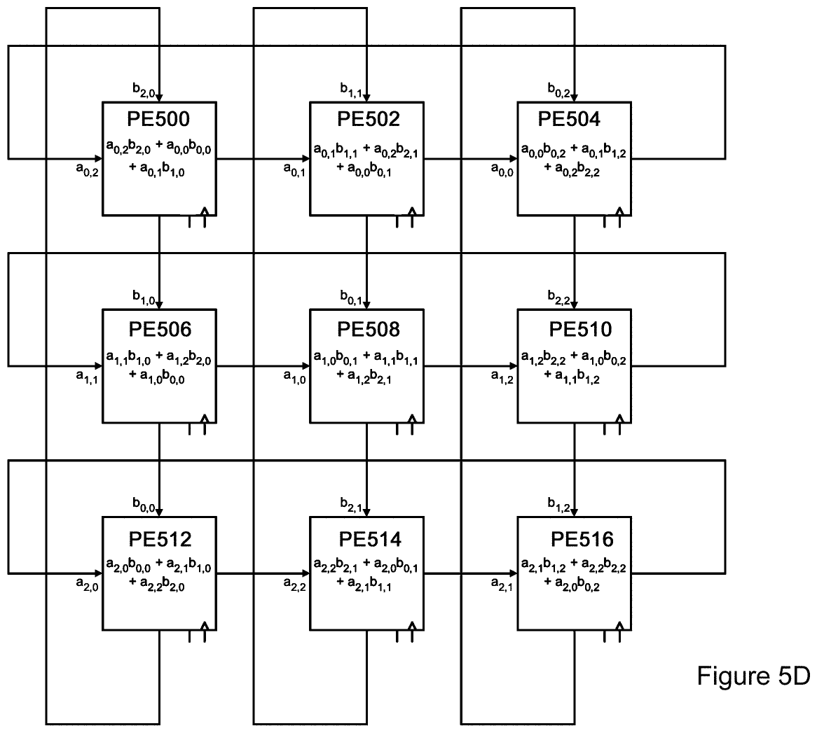

FIG. 1 represents a simplified architecture of a single PE 100. FIGS. 2A-2E are schematic drawings illustrating the structure and operation of an embodiment of PE 100 of FIG. 1. FIG. 3 is a 2×2 toroidal systolic array GEMM processor 300 with PE 100 being the top left PE in the array. FIG. 4 shows the operation of processor 300 over three clock cycles. FIG. 5 shows the operation of a 3×3 toroidal systolic array GEMM processor 500.

Turning to FIG. 1, input a[0][0] 102, input b[0][0] 103 and input g[0][0] 104 are external inputs provided to PE 100 by the user at the beginning of the array operation. a_i, b_i, and g_i are internal inputs to PE 100 from other PEs in the array during the array operation. Similarly, a_o, b_o, and g_o are internal outputs from this PE 100 to other PEs in the array.

This is shown in more detail in FIGS. 3 and 4A-C, but briefly, for the 2×2 array 300 of FIG. 3, output a_o[0][0] 108 is provided by this PE 100 to another PE 200 to the right, and becomes input a_i[0][1] 220 to PE 200 (see FIG. 3). For the 2×2 array of FIG. 3, input a_i[0][0] 120 is provided by PE 200 as a_o[0][1] 208. More generally, a_i[0][0] is provided by the rightmost PE as a_o[0][L−1].

Similarly, output b_o[0][0] 110 is provided by this PE 100 to PE 300 below it, and becomes b_i[1][0] 322 to PE 300. Input b_i[0][0] 122 is provided by PE 300 as b_o[0][1] 322. More generally, b_i[0][0] is provided by the bottom PE as b_o[0][L−1].

The operation of

FIGS. 2A-E are schematic drawings illustrating the structure and operation of an embodiment of PE 100. FIG. 2A shows how selection bits 150A and 150B select external inputs A 102 and B 103, and selection bit 150G may select G 104 at the beginning of the array operation, depending on the operation required.

Having a clear signal to the g register allows cleaning the output register before the next matrix operation when desired, while allowing for subsequent matrix accumulations if needed.

For instance, if the user wants to calculate first G=A*B and then F=C*D (where F, C and D have the same dimension of G, A and B) it would:

1. load A and B

2. perform the systolic array operation to obtain G

3. save G elsewhere where needed

4. load C and D while clearing the G registers

5. perform the systolic array operation to obtain F

6. save the output F matrix

Consider instead the case where the user wants to calculate G=A*B+C*D. In this case it will:

1. load A and B

2. perform the systolic array operation to obtain A*B and store it in the output G registers (now G=A*B)

3. load C and D without clearing the G registers

4. perform the systolic array operation to obtain G=A*B+C*D (in programming pseudo code this is basically G:=G+C*D)

5. save the output G matrix

FIGS. 2B-2E illustrate the second example. Before the array operation, arrays A and B are loaded as shown in FIG. 2B. During the array operation, selection bits 150A and 150B select internal inputs a_i 120 and b_i 122 from other PEs in the array as shown in FIG. 2C-E and FIG. 3. Selection bit 150G (s_g in the figure) will select the internal value fma_o output of the FMA, when le_g is 1, and clear_g is 0. This allows storing the output of the FMA in the g register at every clock cycle.

E.g., s_a 150A is the selection bit of the multiplexer selecting between a_i and a, element of the input matrix A. The idea is that when the user wants to load a new input, (a new A matrix for the array 300), he/she will set le_a to 1, s_a to 1 to route a to a_reg_i (the output of the mux) and give a valid input A 102. In this way at the next clock cycle, the load enable register 152A will effectively store the new input matrix element.

Outputs a_o 108 and b_o 110 are provided to other PEs in the systolic array during array operation, and as outputs at the end of the array operation. E.g., a_o is equal to a for the clock cycle after the user provides a. After that, the user sets s_a to 0 and le_a to 1 for the systolic array to move the data in a toroidal fashion. In this case in the next clock cycle a_o will be equal to a_i (input from the left PE) and not a.

In the general case, input register A 102 and input register B 103 store data on N bits, and accumulator register G 104 stores data on M bits. A mixed precision combinational floating point FMA 154 with two input multiplicand ports on N bits and an input addend port on M bits (with the design constraint of N≤M), provides output data on M bits.

Multiplexers select between data coming from an external data interface (a, b, g) or a neighboring PE in the toroidal systolic array (a_i, b_i, g_i). E.g., a_i is the input that is shifted right in the systolic array. It comes from the left processing element for all the PEs except the leftmost one where it comes instead from the rightmost PE, in a toroidal fashion.

In the embodiment of FIGS. 2A-2E, each register is provided with a synchronous load enable 152A, 152B, 156 that can act also as clock enable when implementing a clock gating synthesis flow. The accumulator register can be loaded with an external value G. The systolic array can work also with simple registers instead of load enable ones.

Systolic Array Architecture

FIG. 3 is a schematic diagram of an example Toroidal Systolic Array Processor 300 comprising four Processing Elements 100, 200, 300, 400. At the beginning of the array operation, External inputs A (104, 204, 304, 404), and inputs B (103, 203, 303, 403) are loaded by the user to start the array operation.

In some embodiments inputs G (104, 204, 304, and 404) are provided by the user to the PEs. Note that in the case of single matrix multiplication this is not necessary. Register g can be cleared (if there are old values from previous operations) while loading A and B. There is no need to provide G.

If for instance the user wanted to calculate G=A*B+C, then the user will load the G registers with C, the A registers with A, and the B registers with B. At the end of the systolic array operation the result will be G=A*B+C

During the array operation, inputs 120, 220, 320, and 420 are provided by PE 200, PE 100, PE 400, and PE 300 respectively, as outputs 208, 108, 408 and 308. Similarly, inputs 122, 222, 322, and 422 are provided by PE 300, PE 400, PE 100, and PE 200 respectively, as outputs 310, 410, 110 and 210.

The design itself makes possible to shift horizontally along the torus row dimension the A registers, shift vertically the B along the torus column dimension, as well as loading new values in the A, B and (for some implementations) G registers.

FIGS. 4A-4C show an example of the Toroidal Systolic Array 500 in operation over three clock cycles. FIG. 1A shows the initial state of the array. PE 100 receives a_{0,1} and b_{1,0}. PE 200 receives a_{0,0} and b_{0,1}. PE 300 receives a_{1,0} and b_{0,0}. PE 400 receives a_{1,1} and b_{1,1}.

FIG. 4B shows the next step in the array process. From the values PE 100 received in FIG. 4A, PE 100 has computed a_{0,1}b_{1,0}. Similarly, PE 200 has computed a_{0,0}b_{0,1}. PE 300 has computed a_{1,0}b_{0,0}. PE 100 has computed a_{1,1}b_{1,1}.

FIG. 4C shows the next step in the array operation. PE 100 received a_{0,0} and b_{0,0} in FIG. 4B, from PE 200 and PE 300 respectively. In FIG. 4C, a_{0,0}b_{0,0} is computed and added to a_{0,1}b_{1,0}, so the result from PE 100 is a_{0,1}b_{1,0}+a_{0,0}b_{0,0}. PE 200 generates a_{0,0}b_{0,1}+a_{0,1}b_{1,1}, PE 300 generates a_{1,0}b_{0,0}+a_{1,1}b_{1,0} and PE 400 generates a_{1,1}b_{1,1}+a_{1,0}b_{0,1}.

Thus, for the equation ab+g, g is the value remaining from the previous operation, while ab is the current multiplication of a and b values received. For PE 400 in FIG. 4C, g is a_{0,1}b_{1,0}, from FIG. 2B. a is a_{0,0} from PE 200 and b is b_{0,0} from PE 300. If the step in FIG. 4C is the last step in the array process, the output g_o[0][0] will be a_{0,1}b_{1,0}+a_{0,0}b_{0,0}.

FIGS. 5A-5D illustrate a similar process for a 3×3 array. Now there are three steps/clock cycles after loading the initial values, and the output has three added elements as shown. PE 500 in the upper left hand corner is provided with a_o_{0,2} (from the upper right PE 504) and b_o_{2,0} from the bottom left PE 512). The bottom center PE 514 is provided a_o_{2,2} (from the bottom left PE) and b_o_{2,1} (from the center PE). Etc. For example, output g_o[0][0] is a_{0,2}b_{2,0}+a_{0,0}b_{0,0}+a_{0,1}b_{1,0}.

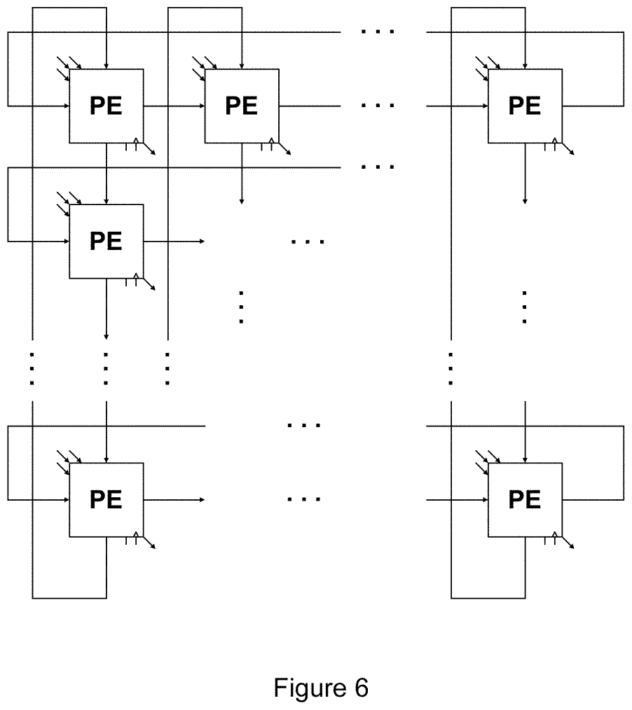

In general, the systolic array will be much larger, e.g. 32×32, 64×64, or even 128×128 or 256×256. FIG. 6 is a simplified schematic diagram of a generic systolic array 600 according to the present invention.

While the exemplary preferred embodiments of the present invention are described herein with particularity, those skilled in the art will appreciate various changes, additions, and applications other than those specifically mentioned, which are within the spirit of this invention. For example, those skilled in the art will understand how to extend these concepts to larger arrays. Input parameters may be chosen to generalize the architecture to different data format and matrix dimensions as needed.

A non-square matrix is enabled by zeroing part of the input matrices A and B. E.g.:

$$A = ( \begin{matrix}{a}_{0 , 0} & {a}_{0 , 1} & {a}_{0 , 2} \\ {a}_{1 , 0} & {a}_{1 , 1} & {a}_{1 , 2} \\ 0 & 0 & 0\end{matrix} )$$

$$B = ( \begin{matrix}{b}_{0 , 0} & {b}_{0 , 1} & 0 \\ {b}_{1 , 0} & {b}_{1 , 1} & 0 \\ {b}_{2 , 0} & {b}_{2 , 1} & 0\end{matrix} )$$

In this case the resulting matrix O=A·B will be a 3×3 matrix with the last row and the last column zeroed:

$$O = ( \begin{matrix}{o}_{0 , 0} & {o}_{0 , 1} & 0 \\ {o}_{1 , 0} & {o}_{1 , 1} & 0 \\ 0 & 0 & 0\end{matrix} )$$

What is claimed is:

1. Apparatus for performing computations in a toroidal manner, the apparatus comprising:
an array of processing elements (PEs) arranged in rows and columns, the array of PEs configured to execute an array operation comprising multiple steps;
input circuitry configured to provide an array of initial first values and an array of initial second values to the array of PEs; and
output circuitry configured to receive an output array of values from the array of PEs;
wherein, for each step of the array operation, the array of PEs is configured to—
perform a fused multiply-add (FMA) operation based upon first values and second values received,
pass a first value to the PE to its right in a row except the PE in the rightmost column of the row which is configured to pass a first value to the PE in the leftmost column of the row, and
pass a second value to the PE below it in a column except the PE in the bottom row of the column which is configured to pass a second value to the PE in the topmost row of the column;
such that the array of PEs receives first values and second values from the input circuitry before the first step of the array operation, receives first values and second values from other PEs in the array of PEs for each step of the array operation, and provides output values to the output circuitry after the array operation.

2. The apparatus of claim 1 further comprising first and second load enable circuitry configured to select whether the first values and the second values the PEs receive are provided by the input circuitry or by other PEs in the array.

3. The apparatus of claim 2 further comprising output load enable circuitry configured to clear a register or store the result of the array operation step in the register.

4. The apparatus of claim 1 configured to compute A*B+C*D by configuring the input circuitry to load array A as initial first values and array B as initial second values, configuring a G register to store the result A*B after performing the array operation, configuring the input circuitry to load array C as initial first values and array D as initial second values, and adding the G register to the C*D result after performing the array operation again.

5. The apparatus of claim 1 configured to compute first G=A*B and then F=C*D by configuring the input circuitry to load array A as initial first values and array B as initial second values, providing output load enable circuitry configured to clear a register or store the result of the array operation in the register and configuring the output load enable circuitry to clear the register after a first array operation computes G=A*B, by configuring the input circuitry to load array C as initial first values and array D as initial second values such that the apparatus to computes F=C*D in a second array operation.

6. The apparatus of claim 1 configured to compute A*B, where A and B are non-square matrices, by including circuitry to pad A and B with zeroes to form square matrices having the same dimensions.
